(19) United States
(12) Patent Application Publication
(10) Pub. No.: US 2015/0037564 A1
(43) Pub. Date: Feb. 5, 2015

(54) COMPOSITE MATERIAL, MANUFACTURING PROCESS THEREFOR AND USES THEREOF

(71) Applicant: GO4HIT.BVBA, Antwerpen (BE)

(72) Inventor: Andrew JOHNSTONE, Boechout (BE)

(73) Assignee: GO4HIT.BVBA, Antwerpen (BE)

(21) Appl. No.: 14/338,713

(22) Filed: Jul. 23, 2014

Related U.S. Application Data
(60) Provisional application No. 61/861,161, filed on Aug. 1, 2013.

(30) Foreign Application Priority Data
Aug. 1, 2013 (EP) 13178965.3

(51) Int. Cl. C08J 9/35; B32B 37/24

(52) U.S. Cl. CPC C08J 9/35; B32B 37/24; C08J 2361/28; C08J 2375/04
USPC 428/317.9; 521/54; 134/6; 156/242

(57) ABSTRACT

A process for producing a composite material comprising the steps of: providing mm-sized particles comprising at least particles of a porous optionally at least partially compressed open-cell melamine formaldehyde resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ to form a block of said composite material; a composite material obtainable by this process; and the use of this composite material for polishing and/or cleaning applications with a liquid.

### TECHNICAL FIELD OF THE INVENTION

The present invention relates to a composite material, a manufacturing process therefor and uses thereof.

### BACKGROUND OF THE INVENTION

A melamine-formaldehyde (M-F) resin is a cross-linked resin produced by condensing melamine with formaldehyde. It has flame resistance (without the addition of flame retardants), chemical resistance, an application temperature up to 240° C., abrasiveness and constant physical properties over a wide temperature range. Porous open-cell M-F resin, also known as open-cell melamine resin foam, additionally has low weight, good thermal insulation properties, high sound insulation capacity and low-temperature flexibility. Porous open-cell M-F resin is used as an insulating and soundproofing material and also as a cleaning abrasive.

Thermoforming is a standard process for providing insulating and soundproofing material with well-defined shapes for use, for example, in the automotive industry. Heat compression is also used to produce cleaning products such as sponges and pads, e.g. for floor cleaning equipment, with a longer lifetime and less liquid take-up than products produced without heat compression. It has highly hydrophilic and oleophilic due to its open-cell structure.

U.S. Pat. No. 4,885,206 discloses a foam composite consisting of (a) one or more layers of a flexible melamine formaldehyde resin foam from 8 to 25 g/l in density and (b) one or more layers of a flexible polyimide foam from 8 to 40 g/l in density.

U.S. Pat. No. 5,413,853 discloses a melamine resin foam comprising a foam body obtained by foaming a resin composition composed mainly of a M-F condensate and a blowing agent, and hydrophobic component coated on said foam body, wherein said hydrophobic component is a silicone resin or a chloroprene rubber.

U.S. Pat. No. 5,436,278 discloses a process for producing a melamine resin foam, which comprises foaming a resin composition comprising a M-F condensate wherein the condensate is obtained by synthesis using a silane coupling agent, a blowing agent and an isocyanate having NCO equivalents of 125-500.

DE 20 2011 04 832U1 discloses scouring pads suitable for microstructured tile surfaces out of mineral materials, characterised in that the wear layer consists of a composite resin, which comprises different resins, preferably consisting of melamine resin of the colours white and grey, stuck together with a water-insoluble adhesive, preferably a hot-melt type adhesive, the individual resin particles having a size of 0.5 to 3 cm³, preferably 1 cm³. No other material is disclosed in DE 20 2011 104 832U1 other than melamine resin and hence there is no support other than for different melamine resin particles stuck together with an adhesive

DE 202004005559U1 discloses cleaning sponge, particularly for cleaning of kitchen crockery, with a first cleaning body (10), which possesses a wiping surface (11) and a coupling surface (12) opposite to the wiping surface (11), and a second cleaning body (20) which possesses a scouring surface (21) and a coupling surface opposite to the scouring surface (21), which adjoins the coupling surface of the first cleaning body, whereby the first cleaning body is firmly bonded with the second cleaning body and whereby the first cleaning body (10) consists of highly resilient polyurethane foam, characterised in that the second cleaning body (20) consists of a melamine resin foam.

EP 633283A1 discloses a melamine resin foam comprising a foam body obtained by foaming a resin composition composed mainly of a M-F condensate and a blowing agent, and hydrophobic component coated on said foam body.

U.S. Pat. No. 6,503,615 discloses a wiping cleaner composed of a porous material of an open-cell structure which has a density of 5 to 50 kg/m³, a tensile strength of 0.6 to 1.6 kg/cm², an elongation at break of 8 to 20%, a cell number of 80 to 300 cells/25 mm, and 1 to 60 parts by weight of an anionic surfactant per 100 parts by weight of the porous material, and which has a fine irregular wiping surface wherein upon wiping, particles are peeled from the wiping surface by friction, wherein the porous material is preferably a melamine resin foam.

US 2007/0157948A discloses a cleaning implement (1) comprising a modified open-cell foam (2) with a density in the range from about 5 to about 1,000 kg/m.sup.3 and with an average pore diameter in the range from about 1 μm to about 1 mm, comprising an amount in the range from about 1 to about 2,500% by weight, based on the weight of the unmodified open-cell foam, of at least about one water-insoluble polymer (b), selected from: polystyrene, styrene copolymers, polybutadiene, butadiene copolymers, polyvinylesters, polyvinylethers, copolymers from (meth)acrylic acid with at least one (meth)acrylate, polyurethanes, polyethylene and wax derivatives thereof, polypropylene and wax derivatives thereof, polyethylene-copolymers, polypropylene-copolymers, and ethylene-propylene-diene-copolymers and combinations thereof; with the proviso that styrene-acrylonitrile-C₁-C₁₀-alkyl (meth)acrylate terpolymers, styrene-butadiene-n-butyl acrylate terpolymers, and styrene-maleic anhydride copolymers are excluded.

US 2010/0273907A1 discloses a modified open-cell aminoplastic foam with a density in the range from 5 to 1,000 kg/m³ and with an average pore diameter in the range from 1 μm to 1 mm, comprising an amount in the range from 1 to 2,500% by weight, based on the weight of the unmodified open-cell foam, of at least one water-insoluble polymer (b), selected from polystyrene, styrene copolymers, polybutadiene, butadiene copolymers, polyvinylesters, polyvinylethers, copolymers from (meth)acrylic acid with at least one (meth)acrylate, and polyurethanes, with the proviso that styrene-acrylonitrile-C₁-C₁₀-alkyl (meth)acrylate terpolymers, styrene-butadiene-n-butyl acrylate terpolymers, and styrene-maleic anhydride copolymers are excluded.

US 2011/0232680A discloses a cleaning implement (1) comprising a hybrid foam (2) wherein said hybrid foam comprises a melamine formaldehyde resin as foamable reactive resins, and a substrate material, wherein said substrate material is selected from the group consisting of mineral fibres, animal fibres, plant fibres, chemical fibres, natural fibres, synthetic fibres, fibers of nonwoven fabrics, fibres of woven materials and mixtures thereof, with the substrate material being preferably selected from the group consisting of polyurethane resins, polyester resins, epoxides and mixtures thereof.

U.S. Pat. No. 8,173,716 discloses an open-cell foam selected from the group of foams based on a M-F condensation product, a polyurethane or a polyimide, wherein the foam has been modified with at least one hydrophobin.

US 2013/0048017A discloses an abrasive pad for cleaning microstructured tile surfaces composed of mineral substances, the abrasive pad comprising: a backing disc; and a wear layer formed of a melamine composite resin including different resin parts bonded with a water-insoluble adhesive. US 2013/0048017A further discloses a cleaning pad to be used in combination with a motorized floor cleaning machine, the cleaning pad comprising: a scrubbing surface made exclusively of melamine composite foam; a backing disc having substantially the same diameter as said scrubbing surface; and a seven-layer water-insoluble glue fixing said backing disc to said melamine composite foam.

Conventional motorized floor cleaning or polishing machines have typically used abrasive floor cleaning pads that are unable to conform to floor surface irregularities. Due to that inability, they cannot adequately clean hard surface floors, especially those with micro-porous systems (depressions and/or scratches), which is necessary to achieve an anti-slip category in public and private areas.

### SUMMARY OF THE INVENTION

It is an object of the present invention to provide a composite material with significantly improved properties including polishing and/or cleaning properties and longer lifetime.

An advantage of the present invention is the capability of the composite material to clean non-slip floors e.g. class R9, R10, R11 and R12 floors under DIN 51130, particularly for concrete and epoxy floors compared with melamine-formaldehyde pads.

A further advantage of the present invention is the capability of the composite material to retain its physical integrity without appreciable loss in thickness when cleaning non-slip floors e.g. class R9, R10, R11 and R12 floors under DIN 51130, particularly for concrete and epoxy floors.

A still further advantage of the present invention is that the composite pads can be used without prewetting of the surfaces to be cleaned.

A still further advantage of the present invention is the capability of the composite material to retain its cleaning properties although the components wear at different rates resulting in a non-flat surface if observed under conditions in which no load is applied to the composite material.

A still further advantage of the present invention is that the abrasivity of the composite material can be varied by varying the M-F resin concentration in the pads so that more soft surfaces, such as linoleum or vinyl floors, and harder surfaces, such as epoxy or marble floors, can be catered for and this can be achieved in a single pad by laminating composite materials with different abrasivities together and using the appropriate composite material for the appropriate floor.

It has been surprising found that pads of the composite material obtainable with the process of the present invention have a longer lifetime as well as being less abrasive when used with a motorised floor cleaning machine than pads using open cell M-F resin even after thermal compression and in particular have a lower tendency to tear. The use of mm-sized particles of latex and/or polyurethane foam in addition to mm-size particles of porous open cell melamine formaldehyde resin e.g. 30 to 70% by weight of polyurethane foam to 70 to 30% by weight of porous open cell M-F resin not only increases the retained bulk-water absorption/mm pad thickness considerably rendering the motorised floor cleaning machine more manageable, but also increases the lifetime of the cleaning pads. The lifetime of such pads is surprisingly further extended by further permanent compression of the composite material in a subsequent thermal compression step, which further increases the retained bulk-water absorption/mm pad thickness. In addition pads, with a composite according to the present invention with latex and open cell M-F resin has the combined effect of both cleaning and polishing in the area of concrete and epoxy floors.

Comparative evaluation of the cleaning pads on the market with the composite materials of the present invention showed that: the pad durability increased in the order of regular M-F resin (e.g. Basotect®) inferior to thermally compressed regular M-F resin (e.g. Basotect®) inferior to the composite foam of white and grey types of open-cell M-F resin marketed by Charlott Produkte Dr Rauwald GmbH inferior to the composite material of the present invention inferior to the composite material of the present invention with additional heat compression treatment.

According to a first aspect of the present invention, a process for producing a composite material is provided, the process comprising the steps of: providing mm-sized particles comprising at least particle of a porous optionally at least partially compressed open-cell melamine formaldehyde resin and mm-sized particles of at least one non-rigid foamed resin; mixing said particles with at least one reactive adhesive in a concentration of 6 to 30 g (preferably 6 to 25 g and particularly preferably 6 to 18 g) of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ (0.050 g/cm³) preferably greater than 65 kg/m³ (0.065 g/cm³) to form a block of said composite material.

According to a second aspect of the present invention, a composite material is provided, the composite material being obtainable by the process according to the first aspect of the present invention.

According to a third aspect of the present invention, a laminate is provided, the laminate comprising the above-mentioned composite material, said laminate preferably comprising a backing material e.g. a material having cleaning properties, such as a synthetic shammy, or a material directly mountable on a cleaning machine or holder and/or a polyurethane foam.

According to a fourth aspect of the present invention, a use is provided for the composite material according to the second aspect of the present invention or the laminate according to the third aspect of the present invention for polishing and/or cleaning applications for example as a pad for polishing and/or cleaning with a liquid, for example water, optionally with at least one cleaning-enhancing additive and/or a degreaser.

According to a fifth aspect of the present invention, a use is provided for the composite material according to the second aspect of the present invention or laminate according to the third aspect of the present invention for insulation applications.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices.

The above and other characteristics, features and advantages of the present invention will become apparent from the following detailed description. This description is given for the sake of example only, without limiting the scope of the invention. The reference figures quoted below refer to the attached drawings.

### BRIEF DESCRIPTION OF THE DRAWINGS

FIG. 1 shows the cleaning effect realised on an R10 antislip epoxy floor with a Wetrok® Servomatic 43 KA motorized floor cleaner with a type D pad adjudged to be very good.

FIG. 2 shows a high resolution black and white image of the original state of the floor clearly showing the structure of the grey-blue epoxy floor coating.

FIG. 3 shows a high resolution black and white image of a track made by cleaning with a Numatic LoLine® NLL332 motorised floor cleaner with a type E pad with just water on the left side and the original dirty floor on the right.

FIG. 4 shows a circular patch showing the original state of the blue-grey epoxy floor coating surrounded by the dirty floor prior to cleaning with the Numatic LoLine® NLL332 motorised floor cleaner with a type E pad.

FIGS. 5 to 9 are different images showing an approximately vertical uncleaned area with on the left a track made by cleaning with a Numatic LoLine® NLL332 motorised floor cleaner with type E pad with water to which degreaser had been added and on the right a track made by cleaning the same motorized floor cleaner with type E pad, but with just water.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B. The meaning of the word “comprising” encompasses all the specifically mentioned features as well as optional, additional, unspecified ones, whereas the term “consisting of” only includes those features as specified in the claim. Therefore, “comprising” includes the term “consisting of”, so that the amendment from the former into the latter term does not extend beyond the content of the application as originally filed.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The following terms are provided solely to aid in the understanding of the invention.

### DEFINITIONS

Melamine has the IUPAC name 1,3,5-triazine-2,4,6-triamine.

The term “mm-sized particles”, as used in disclosing the present invention, means particles having a diameter in the range of ca. 1 mm to ca. 50 mm, preferably in the range of ca. 4 mm to ca. 33 mm and particularly preferably in the range of ca. 8 mm to ca. 25 mm. The size assigned to the mm-sized particles corresponds to the mesh size of the sieve through which the particles pass during comminution. Such particles have a size under the sieving conditions, which is less than or equal to that of the mesh size of the sieve through which they pass and may be agglomerates comprising smaller particles.

The term “non-rigid foamed resin” means that the foamed resin is non-rigid at ambient temperatures, the term differentiating from rigid foamed resin such as expanded polystyrene.

The expression “the composite material is in a pad”, as used in disclosing the present invention, means that the pad comprises the composite material e.g. together with a second reactive adhesive.

The anti-slip surfaces on which cleaning experiments were performed are characterized by the classes of anti-slip surfaces defined in DIN 51130 as given in the table below:

| Class | Frictional coefficient | Slip angle [°] |
|---|---|---|
| R9 | 0.11-0.18 | 6-10 |
| R10 | 0.18-0.34 | 10-19 |
| R11 | 0.34-0.51 | 19-27 |
| R12 | 0.51-0.70 | 27-35 |
| R13 | greater than 0.70 | greater than 35 |

The term “aerial moisture”, as used in disclosing the present invention, means moisture in the air.

HDI is an abbreviation for 1,6-hexane diisocyanate.

TDI is an abbreviation for toluene diisocyanate (toluoylene diisocyanate).

MDI is an abbreviation for methylene diphenyl diisocyanate, which exists in three isomers, 2,2′-MDI, 2,4′-MDI, and 4,4′-MDI (methylene diphenyl 4,4′-diisocyanate, also known as diphenylmethane-4,4′-diisocyanate). The position of the isocyanate groups influences their reactivity. In 4,4′-MDI, the two isocyanate groups are equivalent but in 2,4′-MDI the two groups display highly differing reactivities. The group at the 4-position is approximately four times more reactive than the group at the 2-position due to steric hindrance.

IPDI is an abbreviation for isophorondiisocyanate.

PU is an abbreviation for polyurethane.

M-F resin is an abbreviation for melamine-formaldehyde resin.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

### Process for Producing a Composite Material

According to a first aspect of the present invention, a process for producing a composite material is provided, the process comprising the steps of: providing mm-sized particles comprising at least particles of a porous optionally at least partially compressed open-cell melamine formaldehyde (M-F) resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ (0.050 g/cm³) preferably greater than 65 kg/m³ (0.065 g/cm³) to form a block of said composite material. Such bonding reactions are exothermic and the temperature of the block of composite material may rise to temperatures up to about 100° C. during the bonding process, when allowed to harden in an insulated room.

Performing such bonding reactions without additional heat provides a process which allows for considerable process latitude in respect of the selection of mm-sized porous optionally at least partially compressed open-cell melamine formaldehyde (M-F) resin, mm-sized particles of at least one non-rigid foamed resin and variability in the wetting of these particles by the reactive adhesive e.g. variability in the density of the M-F-resin particles and/or variability in the density of the non-rigid foamed resin particles. Performing such bonding reactions without additional heat also allows for a thorough wetting of the mm-sized particles being bonded and contact between the wetted particles before the hardening process starts in earnest. A thickness of ca. 5 μm of reactive adhesive between contacting particles is thought to be necessary to realize satisfactory mechanical properties in the resulting composite material or foam slab comprising comminuted composite material.

According to a preferred embodiment of the first aspect of the present invention, the mm-sized particles of porous optionally at least partially compressed open-cell M-F resin and at least one non-rigid foamed resin are realized by grinding with a blade-grinder over a sieve, for example a 35 mm, a 25 mm or a 9 mm sieve, to which reduced pressure is applied.

According to a preferred embodiment of the first aspect of the present invention, the different types of mm-sized particles can be deposited and transported on the same transport means to the element in which application of the reactive adhesive to mixing of different types of mm-sized particle taking place or they can be deposited and transported in proportion separately on different transport means to the element in which application of the reactive adhesive to mixing of mm-sized particles takes place, thereby ensuring that the different types of mm-sized particles enter the element in which application of the reactive adhesive to mixing of mm-sized particles takes place in the correct proportions thereby providing a degree of premixing on entry thereto.

According to a preferred embodiment of the first aspect of the present invention, reactive adhesive is applied to each type of mm-sized particle separately with subsequent mixing of the different types of mm-sized particles to which reactive adhesive have been applied with optional additional reactive adhesive. This results in a more homogeneous mixing of the different mm-sized particle types and in improved adhesion. The reactive adhesive applied to the different types of mm-sized particle may be the same or different. Application of the reactive adhesive to the mm-sized particles can be started before all the mm-sized particles have entered the element in which mixing of the mm-sized particles and application of the reactive adhesive thereto takes place. If there is no premixing of the mm-sized particles before entry into this element, this allows the reactive adhesive to be applied to one type of mm-sized particle, e.g. the mm-sized particles of porous optionally at least partially compressed open-cell M-F resin, before it is applied to the other types of mm-sized particles, and even different reactive adhesives to be applied to different types of mm-sized particles.

According to a preferred embodiment of the first aspect of the present invention, the reactive adhesive is a liquid at the temperature at which it is applied to the mixing mm-sized particles. This makes it possible to spray the reactive adhesive onto the mixing mm-sized particles.

According to another preferred embodiment of the first aspect of the present invention, at least two reactive adhesives are used. These reactive adhesives may be provided sequentially, i.e. one after another or overlapping, or simultaneously. If provided simultaneously, they may be provided separately or as a mixture.

Additional heat and possible use of steam will provide a composite material with similar properties in a much shorter process time due to more rapid hardening, but constant product quality will require a much tighter control over the mixing and the particularly the wetting process to ensure that heat and/or steam is applied when sufficient wetting has been achieved to ensure a composite material with satisfactory mechanical properties.

According to another preferred embodiment of the first aspect of the present invention, the particles of porous open-cell M-F are provided by grinding M-F resin comprising porous open-cell and non-porous parts into particles of porous open-cell and non-porous melamine formaldehyde resin and separating said porous open-cell melamine formaldehyde resin particles from said non-porous M-F resin particles, the non-porous M-F resin being preferably a surface skin formed during the manufacture of porous open-cell M-F resin.

According to another preferred embodiment of the first aspect of the present invention, after irreversibly compressing said mixture to a block in a mould without additional heat to a density greater than 50 kg/m³ (0.050 g/cm³) the block is allowed to harden in the block for at least 8 h before cutting to size, with a hardening time of 10 h being preferred.

According to another preferred embodiment of the first aspect of the present invention, the reactive adhesive has a viscosity at 25° C. of 800 to 10,000 mPa·s, with a viscosity at 25° C. of 1,000 to 5,000 mPa·s being preferred and a viscosity at 25° C. of 1,200 to 3,000 mPa·s being particularly preferred.

According to another preferred embodiment of the first aspect of the present invention, the concentration of reactive adhesive in the mixture is 8 to 12 g per 100 g of mm-sized particles.

According to another preferred embodiment of the first aspect of the present invention, the density is at most (i.e. less than or equal to) 90 kg/m³.

According to another preferred embodiment of the first aspect of the present invention, of the mm-sized particles of porous open-cell M-F resin up to 100% by weight of the particles are compressed to some extent, with at least 50% by weight being preferred.

According to another preferred embodiment of the first aspect of the present invention, said mm-sized particles of at least one non-rigid foamed resin are mm-sized particles of latex and/or mm-sized polyurethane foam particles, preferably with at least 10% by weight of said mm-sized particles are mm-sized polyurethane foam particles, with at least 15% by weight being particularly preferred, at least 20% by weight being especially preferred, at least 25% by weight being particularly especially preferred and at least 40% by weight being even more particularly especially preferred.

According to another preferred embodiment of the first aspect of the present invention, said mm-sized particles of a porous optionally at least partially compressed open-cell M-F resin are at most 90% by weight of said mm-sized particles, with at most 85% by weight of said mm-sized particles being preferred, at most 80% by weight of said mm-sized particles being especially preferred, at most 75% by weight of said mm-sized particles being particularly preferred and at most 60% by weight of said mm-sized particles being even more particularly especially preferred.

According to another preferred embodiment of the first aspect of the present invention, said mm-sized particles of at least one non-rigid foamed resin are mm-sized particles of latex and/or mm-sized polyurethane foam particles, preferably with at least 10% by weight of said mm-sized particles are mm-sized latex particles, with at least 15% by weight being particularly preferred, at least 20% by weight being especially particularly preferred, at least 25% by weight being particularly especially preferred and at least 40% by weight being even more particularly especially preferred.

According to another preferred embodiment of the first aspect of the present invention, the mm-sized particles of porous open-cell M-F resin have a volume-averaged particle size, which is a factor of three to five larger than that of the mm-sized particles of non-rigid foamed resin e.g. 35 mm for a porous open-cell M-F resin and 9 mm for a polyurethane foam.

According to another preferred embodiment of the first aspect of the present invention, said mixing process is performed in a mixer (analogously to a concrete mixer), the mixing blades preferably transporting the mixture into the mould. The mixer can be advantageously operated at 85 rpm.

The mould can, for example, have a bottom with the dimensions 2.9×1.06 m² and a height of 0.95 m with holes at 2 cm intervals.

According to another preferred embodiment of the first aspect of the present invention, said reactive adhesive, if a liquid as such or as a solution and if a solid as a solution, is sprayed from at least one nozzle into the stirred mm-sized in said mixing process. This spraying process is carried out at a pressure of 300 to 800 bar (30 to 80 MPa), preferably 400 to 650 bar (40 to 65 MPa).

According to another preferred embodiment of the first aspect of the present invention, the reactive adhesive is an aromatic polyisocyanate, preferably TDI or MDI, or an aromatic polyisocyanate-based prepolymer.

According to another preferred embodiment of the first aspect of the present invention, the process time is in the range of about 3 to about 12 minutes.

According to another preferred embodiment of the first aspect of the present invention, the block of composite materials is exclusive of mineral substances.

According to another preferred embodiment of the first aspect of the present invention, the composite material produced is subsequently permanently thermally compressed by at least 15% under a pressure of 1.5×10³ to 6.0×10³ kg/m², with a compression of 25% being preferred and a compression of 40% being particularly preferred.

According to another preferred embodiment of the first aspect of the present invention, the composite material produced from a mixture of mm-sized particles of open-cell M-F resin and mm-sized polyurethane particles is subsequently permanently compressed by at least 15% at a temperature of 180 to 220° C. under a pressure of 1.5×10³ to 6.0×10³ kg/m², with a compression of 25% being preferred and a compression of 40% being particularly preferred. It has been found that the higher the compression temperature, the shorter the compression time required, a time of about two minutes being preferred at a temperature of about 220° C.

According to another preferred embodiment of the first aspect of the present invention, the block of said composite material is subjected to comminution and the resulting mm-sized particles mixed with a second reactive adhesive in a concentration of 3 to 18 g (preferably 6 to 15 g) of said second reactive adhesive per 100 g of mm-sized comminuted composite material particles and said mixture is irreversibly compressed in a mould without additional heat to a density greater than 100 kg/m³, preferably greater than 130 kg/m³ and particularly preferably greater than 145 kg/m³ to form a foam slab comprising the composite material, with a density preferably less than 300 kg/m³, especially preferably less than 250 kg m³, particularly preferably less than 225 kg/m³ and particularly especially preferably less than 200 kg/m³; and is optionally subsequently permanently compressed by at least 10% at a temperature of 180 to 260° C., with a temperature of 180 to 220° C. being preferred, under a pressure of 1.5×10³ to 6.0×10³ kg/m². It has been found that the higher the compression temperature, the shorter the compression time required, a time of about two minutes being preferred at a temperature of about 220° C. The reactive adhesive and the second reactive adhesive may be the same reactive adhesive. An accelerator may be present during at least part of the mixing process.

### Composite Material

According to a second aspect of the present invention, a composite material is provided, the composite material being obtainable by the process according to the first aspect of the present invention.

According to a preferred embodiment of the second aspect of the present invention, the composite material comprises polyurethane bonding between said mm-sized optionally at least partially compressed porous open-cell M-F resin particles, wherein said polyurethane bonding is a result of the reaction of a polyisocyanate with reactive groups in said resin particles in the presence of aerial moisture and preferably in the presence of a catalyst to accelerate said bonding process (accelerator).

According to another preferred embodiment of the second aspect of the present invention, the composite material is exclusive of abrasive particles in addition to the particles of a porous open-cell M-F resin.

According to another preferred embodiment of the second aspect of the present invention, the composite material is exclusive of mineral substances.

According to another preferred embodiment of the second aspect of the present invention, the composite material is at least 3 mm thick, with at least 5 mm thick being preferred.

The composite materials according to the present invention can, e.g., contain:

| | | porous open-cell |
|---|---|---|
| PU foam (wt % of | latex (wt % of | not-thermally-compressed M-F |
| particles) | particles) | resin (wt % of particles) |
| | 50 | 50 |
| 87.1 | | 12.9 |
| 86.4 | | 13.6 |
| 85.9 | | 14.1 |
| 84.1 | | 15.9 |
| 70.6 | | 29.4 |
| 50 | | 50 |
| 40 | | 60 |

### Melamine-Formaldehyde Resin

In CA 1151350A BASF disclose a process for the preparation of a resilient foam based on a melamine-formaldehyde (M-F) condensate, wherein a very concentrated aqueous solution or dispersion which contains a M-F precondensate, an emulsifier, a volatile blowing agent and a curing agent is foamed under conditions such that initially there is only a slight increase in viscosity and the curing process, accompanied by a large increase in viscosity, only commences when foaming has substantially ended. The molar ratio of melamine to formaldehyde in the precondensate can vary within wide limits, namely from 1:1.5 to 1:4. The degree of condensation of the pre condensate should be sufficiently low to allow curing accompanied by further condensation. The mean molecular weight, measured osmometrically, can be from 200 to 1,000. The aqueous solution or dispersion of the melamine resin contains an emulsifier, preferably in an amount of from 0.5 to 5% by weight. The purpose of the emulsifier is to disperse the organic blowing agent homogeneously in the aqueous solution or dispersion; accordingly, the emulsifier ensures the stability of the system and prevents phase separation during foaming; such phase separation would result in an inhomogeneous foam. The higher the foaming temperature, the more effective the emulsifier must be, and the higher should be the concentration used. The aqueous solution or dispersion additionally contains a volatile blowing agent, preferably boiling at from −20 to 100° C. e.g. hydrocarbons, halohydrocarbons, alcohols, ketones, ethers and esters. The curing agents employed are compounds which under the reaction conditions split off, or form, protons, which then catalyze the further condensation of the melamine resin. The amount used is from 0.01 to 20% by weight, based on the resin. Examples of suitable compounds are inorganic and organic acids. A critical feature a) of the present invention is the concentration of the pre condensate in its mixture with water (without additives). The optimum concentration is different for every foaming temperature, i.e. it depends on the nature of the blowing agent.

EP 17671A and EP 17672A disclose flexible foams based on an M-F condensation product which are notable for low density, good heat and sound insulation capability and favourable mechanical properties. They show standard or low flammability under German Standard Specification DIN 4102.

BASF manufactures melamine resin foam having open cells as Basotect® in the form of blocks with low density (less than 10 kg/m³), good cleaning qualities, excellent sound absorption, a high flame-retardancy and temperature resistance.

The open cell M-F resin particles used in the process of the first aspect of the present invention are selected from particles produced by comminution of open-cell M-F blocks with a density of about 8 to about 12 kg/m³ as produced in the above-mentioned processes and from open-cell M-F blocks produced in the above-mentioned processes which has subsequently been subjected to thermal compression. The degree of thermal compression of open-cell M-F blocks which are then subject to comminution to mm-sized particles can be up to 85%. Hence, the M-F particles used can comprise particles from blocks without thermal compression and particles from blocks compressed at 210 to 240° C. for 4 to 4.5 minutes, depending upon the characteristics of the block supplied, with degrees of compression up to 85% e.g. a 20 mm thick block can be reduced in thickness to 3 mm, increasing the density from ca. 10 kg/m³ to ca. 67 kg/m³.

### Reactive Adhesives

A very wide range of commercially available reactive adhesives can be used for bonding the porous open-cell M-F resin particles, polyurethane foams and latexes of the present invention e.g. at least bifunctional compounds such as polyisocyanates which react with reactively available groups, e.g. hydroxy groups, on the mm-sized particles of polyurethane foam, mm-sized latex particles and mm-sized optionally at least partially compressed porous open-cell M-F resin particles of the present invention. The reactive adhesive can be a liquid, which can be applied as such or as a solution in a solvent, or a solid, in which case it is applied as a solution in a solvent.

According to another preferred embodiment of the first aspect of the present invention, said at least one reactive adhesive comprises a component with at least three reactive groups providing crosslinking of the composite material e.g. NeoRez® R-2212, NeoCryl® XK-17 and Crosslinker CX-100, a polyfunctional azidirine crosslinker from DSM NeoResins B.V.

According to another preferred embodiment of the first aspect of the present invention, said reactive adhesive is a polyisocyanate, said polyisocyanate being selected from the group consisting of aliphatic and aromatic polyisocyanates, with at least one aromatic polyisocyanate being preferred and with at least one aromatic polyisocyanate selected from the group consisting of diphenylmethane diisocyanates and toluene diisocyanates being particularly preferred.

Particularly suitable polyisocyanates are derived from or based on polyisocyanates or mixtures thereof e.g. 1,6-hexane diisocyanate (HDI); toluoylene diisocyanate (TDI); diphenylmethane-4,4′-diisocyanate (MDI); 1,4-cyclohexane diisocyanate and 4,4′-diisocyanate-dicyclohexylmethane; isophorondiisocyanate (IPDI); triphenylmethane-4,4′,4″-tri-isocyanate, thiophosphoric acid tris(p-isocyanatophenyl ester), with polyisocyanate prepolymers based on aromatic diisocyanates, such as diphenylmethane diisocyanates and toluene diisocyanates e.g. with polyols, being preferred.

Huntsman produces a large variety of MDI polyisocyanates under the trade name SUPRASEC e.g. SUPRASEC® 1000, pure MDI; SUPRASEC® 1004, modified MDI; SUPRASEC® 1007, MDI-based; SUPRASEC® 1100, pure MDI; SUPRASEC® 1306, pure MDI; SUPRASEC® 1400, pure MDI; SUPRASEC® 1412, MDI-based; SUPRASEC® 1612, MDI-based; SUPRASEC® 2004, modified MDI; SUPRASEC® 2008, MDI-based; SUPRASEC® 2010, MDI-based; SUPRASEC® 2018, MDI-based; SUPRASEC® 2020, modified MDI; SUPRASEC® 2021, MDI-based; SUPRASEC® 2023, MDI-based; SUPRASEC® 2029, modified MDI; SUPRASEC® 2030, MDI-based; SUPRASEC® 2034, MDI-based; SUPRASEC® 2049, MDI-based; SUPRASEC® 2050, MDI-based; SUPRASEC® 2054, MDI-based; SUPRASEC® 5005, polymeric MDI; SUPRASEC® 5025, polymeric MDI; and SUPRASEC® 5030, polymeric MDI.

Bayer Materials Science AG, Germany produces a large variety of polyisocyanates and blocked polyisocyanates under the trade name DESMODUR e.g. DESMODUR® N75, a 75% solution of a biuret HDI, DESMODUR® N100, a biuret HDT; DESMODUR® N3200, a biuret HDI (lower viscosity than DESMODUR® N100); DESMODUR® N3300, an HDI isocyanurate; DESMODUR® N3390, a 90% solution of an HDI isocyanurate; DESMODUR® L75, a 75% solution of a TDI-adduct, DESMODUR® IL, a TDI-isocyanurate; DESMODUR® IL 1351, a TDI-polyisocyanate; DESMODUR® HL, a TDI/HDI-polyisocyanate; DESMODUR® VL, a MDI-polyisocyanate; and DESMODUR® Z4370, an IPDI-isocyanurate.

Dow Chemical produces a range of modified MDI polyisocyanates including the MDI prepolymers for rebonding foam: Voramer™ RF1025, Voramer™ RF 1026, Voramer™ RF1033, Voramer™ MR1101, Voramer™ MF1056 and Voramer™ MF1503, with Voramer™ MF1503 and Voramer™ RF1026 being particularly preferred. Although Voramer™ MF1503 is recommended by Dow Chemical for use with latex foam, it has been found to be particularly useful as a reactive adhesive with mm-sized porous open-cell M-F resin particles and mm-sized polyurethane latex particles.

### Accelerator

The concentration of reactive adhesive used can be reduced by using at least one accelerator i.e. a catalyst to accelerate the reaction between the reactive adhesive and reactive groups on the mm-sized particles being bonded together.

According to another preferred embodiment of the first aspect of the present invention, at least one accelerator is present during at least part of said mixing process, said accelerator being preferably selected from the group consisting of alkali's, amines (e.g. dimorpholino diethyl ether and tertiary amines, e.g. 4-phenylpropylpyridine, 1-methyl-imidazole and 1-vinylimidazole), metal carboxylates (e.g. zinc octoate), alkylmetal-carboxylates (e.g. dibutyltin dilaurate), and particularly preferably a tertiary amine.

### Latex

Synthetic rubber is made by the polymerization of a variety of petroleum-based precursors called monomers. The most prevalent synthetic rubbers are styrene-butadiene rubbers (SBR) derived from the copolymerization of styrene and 1,3-butadiene. Other synthetic rubbers are prepared from isoprene (2-methyl-1,3-butadiene), chloroprene (2-chloro-1,3-butadiene), and isobutylene (methylpropene) with a small percentage of isoprene for cross-linking. These and other monomers can be mixed in various proportions to be copolymerized to produce products with a range of physical, mechanical, and chemical properties. The monomers can be produced pure and the addition of impurities or additives can be controlled by design to give optimal properties. Polymerization of pure monomers can be better controlled to give a desired proportion of cis and trans double bonds. Such latexes have a density of about 55 to about 85 kg/m³.

According to a preferred embodiment of the first aspect of the present invention, the latex (e.g. synthetic rubber latex) is prepared with at least one monomer selected from the group consisting of styrene, 1,3-butadiene, isoprene, chloroprene, neoprene and isobutylene.

### Polyurethane Foam

Polyurethane (PU) is a polymer composed of a chain of organic units joined by carbamate (urethane) links. Polyurethane polymers are formed by reacting an isocyanate containing two or more isocyanates groups per molecule (R—(N═C═O)_{n≧2}) with a polyol containing on average two or more hydroxy groups per molecule (R′—(OH)_{n≧2}), in the presence of a catalyst. PU foam (including foam rubber) is optionally made using small amounts of blowing agents to give less dense foam, better cushioning/energy absorption or thermal insulation. The choices available for the isocyanates and polyols, in addition to other additives and processing conditions allow PU's to have the very wide range of properties that make them such widely used polymers.

Aromatic or aliphatic isocyanates can be used, the aromatic isocyanates, diphenylmethane diisocyanate (MDI) or toluene diisocyanate (TDI) are more reactive than aliphatic isocyanates, such as hexamethylene diisocyanate (HDI) or isophorone diisocyanate (IPDI). Isocyanates with functionality greater than two act as crosslinking sites.

Polyols are polymers in their own right and have on average two or more hydroxyl groups per molecule. Polyether polyols are mostly made by polymerizing ethylene oxide and propylene oxide. Polyester polyols are made similarly to polyester polymers. The polyols used to make polyurethanes are not “pure” compounds since they are often mixtures of similar molecules with different molecular weights and mixtures of molecules that contain different numbers of hydroxyl groups, which is why the “average functionality” is often mentioned. Despite their being complex mixtures, industrial grade polyols have their composition sufficiently well controlled to produce PU's having consistent properties. Polyols used to make rigid PU's have molecular weights in the hundreds, while those used to make flexible PU's have molecular weights up to ten thousand or more.

According to a preferred embodiment of the first and second aspects of the present invention, the polyurethane foam is prepared with at least one polyisocyanate selected from the group consisting of aliphatic and aromatic polyisocyanates, with at least one aromatic polyisocyanate being preferred and with at least one aromatic polyisocyanate selected from the group consisting of diphenylmethane diisocyanates and toluene diisocyanates being particularly preferred.

According to a preferred embodiment of the first and second aspects of the present invention, the polyurethane foam is prepared with at least one polyol selected from the group consisting of polyether polyols and polyester polyols.

Such polyurethane foams have a density of about 16 to about 60 kg/m³. The lower the density of the polyurethane foam the higher the compliance.

### Laminate

According to a third aspect of the present invention, a laminate is provided, the laminate comprising the composite material of the second aspect of the present invention.

According to a preferred embodiment of the third aspect according to the present invention, the laminate further comprises a backing material e.g. woven or non-woven microfibres, woven or non-woven macrofibres (e.g. a polyester fibre scouring material), woven or non-woven textiles, a material having cleaning properties [e.g. chammy, shammy, a synthetic shammy (e.g. non-woven viscose rayon), or a material directly mountable on a cleaning machine or holder] and/or a polyurethane foam. The backing material having cleaning properties could be a block of porous open-cell melamine formaldehyde resin, a block of composite material, according to the present invention, or a foam slab comprising said composite material, according to the present invention. For example, a laminate having a backing material comprising a composite material, according to the present invention, with a higher or lower concentration of porous open-cell M-F resin than the block of composite material, according to the present invention, or foam slab comprising said composite material, according to the present invention, to which it is directly or indirectly laminated, would provide a laminate of composite materials, according to the present invention, and/or foam slabs comprising composite material, according to the present invention, with different cleaning properties.

According to another preferred embodiment of the third aspect according to the present invention, the laminate comprises a backing material laminated directly or indirectly to a block of said composite material or to a foam slab comprising said composite material, said backing material being preferably a woven material, a non-woven material or Velcro®.

According to another preferred embodiment of the third aspect according to the present invention, the laminate comprises as backing material a synthetic shammy laminated directly or indirectly to the composite material, thereby producing a laminate whose two sides can be used for cleaning and drying respectively.

According to another preferred embodiment of the third aspect according to the present invention, the laminate comprises a backing material directly mountable on a cleaning machine or holder, said backing material directly mountable on a cleaning machine or holder being preferable a woven material, a non-woven material (e.g. non-woven polypropylene) or Velcro®.

According to another preferred embodiment of the third aspect of the present invention, the laminate further comprises as backing material a PU sponge, thereby producing a laminate whose two sides can be used for cleaning and mopping up of the resulting dirty water thereby produced respectively.

According to another preferred embodiment of the third aspect of the present invention, the laminate comprises a protective layer, which either can be stripped off or is dissolved in initial use to provide a cleaning surface.

Lamination can be realized with hot melt sheet or a water-based or solvent-based glue, with hot melt sheets and water-based glues being preferred and water-based glues being particularly preferred e.g. Simalfa® 3150F from ALFA Klebstoffe AG, a pressure sensitive water-based contact adhesive which is a dispersion of synthetic rubber, and the Vinnapas water-based adhesives from Wacker Chemie.

### Use of the Composite Material

The composite material of the second aspect of the present invention and obtained by the process of the first aspect of the present invention can be used for a multiplicity of purposes including various cleaning applications and various insulation applications including noise and heat insulation. For insulation applications the composite material, according to the present invention, or foam slab comprising composite material, according to the present invention, may also comprise flame retardants and other additives which are standard for such applications.

According to a fourth aspect of the present invention, a use is provided for the composite material according to the second aspect of the present invention or laminate according to the third aspect of the present invention for polishing and/or cleaning applications with a liquid, preferably water, optionally with at least one cleaning-enhancing additive e.g. a degreaser, an alkaline cleaning-enhancing additive of an abrasive cleaning-enhancing additive.

According to a preferred embodiment of the fourth aspect of the present invention, the composite material is a pad and the liquid does not comprise a cleaning-enhancing additive.

According to another preferred embodiment of the fourth aspect of the present invention, the composite material is in the pad and the liquid does not comprise a cleaning-enhancing additive.

According to another preferred embodiment of the fourth aspect of the present invention, the composite material is a pad and the liquid comprises at least one alkaline cleaning-enhancing additive. Examples of cleaning enhancing additives are the range of alkaline cleaners and floor cleaners from Wetrok e.g. Antiwax, a universal cleaner, Antiwax-forte, an alkaline industrial cleaner, Indumat, a universal cleaner, Klar, a soap cleaner, Reline, an alkaline cleaner for linoleum, Remat, an alkaline cleaner, Remat forte, an alkaline cleaner, Reshine, a universal cleaner, and Rewit 2000, a universal cleaner.

According to another preferred embodiment of the fourth aspect of the present invention, the composite material is a pad and the liquid comprises at least one abrasive cleaning-enhancing additive.

According to another preferred embodiment of the fourth aspect of the present invention, the composite material is in the pad and the liquid comprises at least one abrasive cleaning-enhancing additive.

The pads may, for example, be cleaning discs 8 to 21 inches (20.32 to 53.34 cm) in diameter, cleaning wipes, cleaning sponges or replaceable sponges for mops.

According to another preferred embodiment of the fourth aspect of the present invention, the liquid comprises a non-alkaline degreaser, for example a degreaser which does not render aluminium white upon cleaning, with a combination with a defoaming agent, e.g. a silicone-based defoamer such as an emulsion of poly(dimethylsiloxane); EO/PO based defoamers, e.g. Foam Clean FC-series (e.g. FC-110) from GL Chem. The non-alkaline degreaser is preferably present in a concentration of about 0.10 Brix (0.10% by weight of solids) to about 1.00 Brix (1.0% by weight of solids). The degreaser is a detergent, which is preferably completely water-soluble and non-foaming. Examples of suitable degreasers are Chrisal Floor Cleaner Extra from Chrisal NV, Belgium, Biomex HDI from DCP Chemicals with a Brix value of 15 and a preferred dilution of 1:20; and the Libero Universal Cleaner from Wetrok.

According to another preferred embodiment of the fourth aspect of the present invention, the liquid comprises a non-alkaline degreaser.

According to another preferred embodiment of the fourth aspect of the present invention, the composite material is a pad and the pad is shaped to fit into or onto a tool, which can be a hand-held tool, such as a mop, or a motorized tool such as a cleaning machine.

According to another preferred embodiment of the fourth aspect of the present invention, the composite material is a pad and the pad is used in combination with a motorized floor cleaning machine on which it is mounted.

According to another preferred embodiment of the fourth aspect of the present invention, the composite material is in a pad and the pad is used in combination with a motorized floor cleaning machine on which it is mounted.

Mounting of the pad on the motorized floor cleaning machine can be realised by attaching Velcro® to it or lamination to a standard attachment for motorized floor cleaning machines using a hot melt sheet or a water-based or solvent-based glue, with hot melt sheets and water-based glues being preferred and water-based glues being particularly preferred e.g. Simalfa® 3150F from ALFA Klebstoffe AG, a pressure sensitive water-based contact adhesive which is a dispersion of synthetic rubber, and the Vinnapas water-based adhesives from Wacker Chemie. Mounted on a motorized floor cleaning machine composite pads according to the present invention are capable with degreaser-containing water of cleaning non-slip floors up to class R12 with a slip angle of 27-35 and a coefficient of friction of 0.51-0.70 under DIN 51130 and without appreciable wear up to class R11 with a slip angle of 19-27 and a coefficient of fraction of 0.34-0.51 under DIN 51130. Although after use the latex and/or PU parts of the dried pads stand proud of the open-cell M-F resin, upon wetting and contact with the floor the softer latex and/or PU parts of the pad are compressed thereby presenting a flat cleaning surface to the floor in which cleaning effectiveness of the open-cell M-F resin is undiminished. Subsequent thermal compression of the composite material after production surprisingly results in superior wear characteristics over composite material not subjected to subsequent thermal compression.

Small industrial and domestic motorized floor cleaning machines for cleaning purposes typically operate at 150 to 375 rpm. Higher rotation speeds are typically used for polishing floors.

Floors with an antislip finish with antislip characteristics up to class R12 under DIN 51130 are installed by Resitec, Belgium, although R12 is reserved for downhill floors in humid area's. Less than 3% of the antislip finished installed by Resitec, Belgium, have antislip characteristics of Class R12.

According to a fifth aspect of the present invention, a use is provided for the composite material according to the second aspect of the present invention or laminate according to the third aspect of the present invention for insulation applications.

### EXAMPLES

The floor cleaning tests were performed with various types of motorized floor cleaner as specified under the particular series of experiments either with a single 13 inch (33 cm) diameter pads laminated with a non-woven polypropylene backing which was attachable to the floor cleaner or with two 13 inch (33 cm) diameter pads each laminated with a non-woven polypropylene backing. The tests were performed on an industrial “flat floor” i.e. a concrete a floor and floors with an epoxy finish and with a terrazzo finish all with only minor surface irregularities and epoxy-finished floors with type R10 and R11 anti-slip surfaces according to DIN 51130, e.g. an Artline® floor coating. The Soltec Artline® floor coating is applied to concrete or screed which is clean, dust-free, dry, at least three weeks old and provided with an impregnation primer in the case of porous surfaces by applying four epoxy-layers, the first two with black particles dispersed therein which after hardening are sealed with two colourless epoxy layers thereby providing an epoxy R11-antislip surface according to DIN 51130.

The M-F pads used in the comparative experiments were cut from blocks of M-F resin and were not subjected to thermal compression. The pads used in the invention experiments were produced by the process of the first aspect of the present invention in which mm-sized particles comprising at least particles of a porous optionally at least partially compressed open-cell M-F resin and mm-sized particles of latex and/or mm-sized PU particles; mixing the particles with at least one reactive adhesive in a concentration of 6 to 18 g of aromatic polyisocyanate per 100 g of mm-sized particles; reacting the reactive adhesive with the particles in the presence of aerial moisture thereby bonding the particles together during the mixing process; transporting the mixture into a mould; and irreversibly compressing the mixture to a block in a mould without additional heat to a density greater than 0.50 g/cm³ to form a block of the composite material of the present invention to produce the following composite materials:

composite material

| | M-F particles# | latex particles | PU-foam particles | 25% thermal |
|---|---|---|---|---|
| | (wt % of | (wt % of | (wt % of | compression |
| | particles) | particles) | particles) | at 200° C. |
| A | 70 | 30 | — | no |
| B | 70 | — | 30 | no |
| C | 50 | 50 | — | no |
| D | 50 | — | 50 | no |
| E | 50 | — | 50 | yes |

#manufacturer 1

The weights of 33 cm (13 inch) diameter pads of M-F and of composite materials D and E are given in Table 1 together with the pad thickness and densities.

TABLE 1

| composite | | | | density |
|---|---|---|---|---|
| material | Pad thickness [mm] | weight [g] | volume [m³] | [kg/m³] |
| 100* M-F resin | 20 | 14 | 1.710 × 10⁻³ | 8.2 |
| 100# M-F resin | 25 | 97 | 1.996 × 10⁻³ | 48.6 |
| D | 20 | 109 | 1.710 × 10⁻³ | 63.7 |
| | 20 | 127 | 1.710 × 10⁻³ | 74.3 |
| E | 15 | 119 | 1.283 × 10⁻³ | 92.7 |
| | 15 | 118 | 1.283 × 10⁻³ | 92.0 |

*pads are cut from blocks of M-F resin without thermal compression
#pads are cut from blocks of blends of mm sized particles of M-F resin with different qualities (white and grey) supplied by Charlott Produkte Dr Rauwald GmbH and have a central hole 85 mm in diameter

Water absorption tests were carried out on 33 cm (13 inch) diameter pads of M-F pad and composite materials D and E. The weights are given below before water absorption, immediately after 30 s submersion and after 30 s hanging in Table 2 below.

TABLE 2

| | | | | | Water | Water | | Water |
|---|---|---|---|---|---|---|---|---|
| | | | Pad weight | | absorbed | retained | | retained |
| | | | immediately | Water | by | by pad | Water | by |
| | Pad | Initial | after 30 s | absorbed | pad/mm | after 30 s | retained | pad/mm |
| composite | thickness | weight | immersion | by | thickness | of hanging | by | thickness |
| material | [mm] | [g] | in water [g] | pad [g] | [g] | [g] | pad [g] | [g] |
| 100* M-F | 20 | 14 | 1570 | 1556 | 77.8 | 820 | 806 | 40.3 |
| resin | 20 | 14 | 1583 | 1569 | 78.4 | 785 | 771 | 38.55 |
| 100# M-F | 25 | 97 | 1829 | 1732 | 69.3 | 1576 | 1479 | 59.16 |
| resin | 25 | 97 | 1792 | 1695 | 67.8 | 1558 | 1461 | 58.44 |
| D | 20@ | 109 | | | | 1040 | 931 | 46.55 |
| | 20@ | 109 | | | | 1057 | 948 | 47.40 |
| | 20 | 127 | 1671 | 1544 | 77.2 | 1154 | 1027 | 51.35 |
| | 20 | 127 | 1745 | 1618 | 80.9 | 1361 | 1234 | 61.7 |
| | 20 | 127 | 1709 | 1582 | 79.1 | 1298 | 1171 | 58.55 |
| E | 15@ | 119 | | | | 1010 | 891 | 59.40 |
| | 15@ | 119 | | | | 1026 | 907 | 60.46 |
| | 15 | 118 | 1151 | 1033 | 68.87 | 925 | 807 | 58.0 |
| | 15 | 118 | 1191 | 1073 | 71.53 | 990 | 872 | 58.1 |

*pads are cut from blocks of M-F resin without thermal compression
#pads are cut from blocks of blends of mm sized particles of M-F resin with different qualities (white and grey) supplied by Charlott Produkte Dr Rauwald GmbH with an 85 mm diameter hole
@water absorption experiments performed with pads laminated with a 5 mm thick and 33 cm in diameter backing pad of non-woven polypropylene weighing 30 g

The absorption of water measured immediately after immersion in water for 30 s, when the thickness of the pads is taken into account, are identical for non-thermally-compressed pads. However, there are considerable differences in the quantity of water retained after hanging for 30 s, when the thickness of the pads is taken into account. Whereas, in the case of pads of M-F resin about 40 g of water is retained/mm this increases to 50-60 g/mm for the pad of composite material D with 50 wt % M-F resin particles and 50 wt % polyurethane particles and M-F resin blend supplied by Charlott Produkte Dr Rauwald GmbH and composite material E produced upon compressing composite material D both exhibited about 60 g/mm.

### Examples 1 to 6

### Evaluation of Pads Comprising the Composite Material According to the Present Invention on Floors with Minor Surface Irregularities with Water Only i.e. without Cleaning-Enhancing Additives

The observations made in the evaluation of 33 cm (13 inch) diameter pads of M-F resin and type A, B, C, D and E composite materials on the cleaning of industrial floors using a Wetrok® Servomatic 43 KA motorised floor cleaner with a single pad rotating at 160 rpm and water without any cleaning-enhancing additives are summarized in Table 3 below.

TABLE 3

| | | Initial | cleaning | | cleaning |
|---|---|---|---|---|---|
| | | pad | quality | polishing effect | lifetime with |
| | composite | thickness | epoxy | terrazzo and | motorized floor |
| Example | material | [mm] | floors | concrete | cleaner [m] |
| 1 (comparative) | 100* M-F resin | 20 | good | none | <1515 |
| 2 (invention) | A | 20 | good | none | |
| 3 (invention) | B | 20 | good | none | |
| 4 (invention) | C | 20 | good | visibly observable | >3030 |
| 5 (invention) | D | 20 | good | none | >3030 |
| 6 (invention) | E | 15 | good | none | >3030 & <4545 |

*pads are cut from blocks of M-F resin without post-manufacturing thermal compression

The cleaning effect realised on epoxy floors with a R10 non-slip surface with all the pads evaluated was adjudged to be good, but pads of type C, D and E composite materials according to the present invention exhibited significantly longer lifetimes i.e. greater than 3030 m (1000 m²) travelled compared with less than 1515 m (500 m²) travelled with the pad of M-F resin without post-manufacturing thermal compression. Furthermore, a visible polishing effect was observed with the pad of type C composite material on terrazzo and concrete floors.

### Examples 7-12

### Evaluation of Pads Comprising the Composite Material According to the Present Invention with Water with Degreaser with Floors with Minor Surface Irregularities

The observations made in the evaluation of 33 cm (13 inch) diameter pads of M-F resin and type A, B, C, D and E composite materials on the cleaning of industrial floors using a Wetrok® Servomatic 43 KA motorised floor cleaner with a single pad rotating at 160 rpm And water with a degreaser (100 mL of 5 Brix in 3 L of water i.e. 0.17 Brix) are summarized in Table 4 below.

TABLE 4

| | | | | | cleaning | polishing |
|---|---|---|---|---|---|---|
| | | Initial | | | lifetime with | effect |
| | | pad | cleaning | damage to pads after | motorized | terrazzo |
| | composite | thickness | quality | 2285 m cleaning of | floor cleaner | and |
| Example | material | [mm] | epoxy floors | epoxy floor | [m] | concrete |
| 7 (comp.) | 100* M-F | 20 | very good | parts ripped off | <1515 | none |
| | resin | | | | | |
| 8 (inv.) | A | 20 | very good | little wear/damage | | none |
| 9 (inv.) | B | 20 | very good | little wear/damage | | none |
| 10 (inv.) | C | 20 | very good | little wear/damage | >3030 | visibly |
| | | | | | | observable |
| 11 (inv.) | D | 20 | very good | little wear/damage | >3030 | none |
| 12 (inv.) | E | 15 | very good | very little | >4545 | none |
| | | | | wear/damage | | |

*pads are cut from blocks of M-F resin without post-manufacturing thermal compression

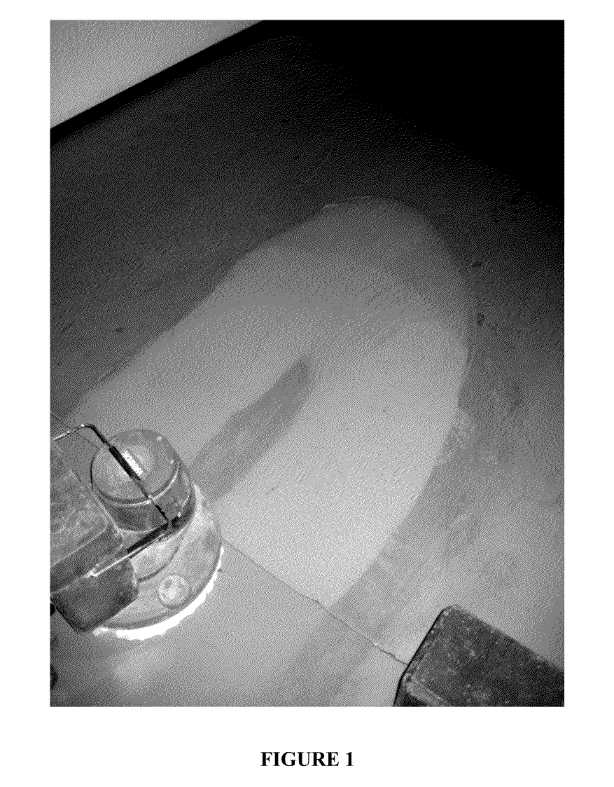

The cleaning effect realised on epoxy floors with a R10 non-slip surface with all the pads evaluated was adjudged to be very good i.e. superior to the cleaning effect observed with water without cleaning-enhancing additives as shown in FIG. 1 for a type D pad, but pads of type C, D and E composite materials according to the present invention exhibited significantly less wear and longer lifetimes i.e. little wear or very little wear and greater than 3030 m (1000 m²) travelled compared with parts ripped off and less than 1515 m (500 m²) travelled with the pad of M-F resin without post-manufacturing thermal compression. Moreover, the wear of the pad of composite material E after travelling 4545 m (1500 m²) was less i.e. the damage to the pad was less than that observed with pads of type A, B, C and D composite materials. Here again a visible polishing effect was observed with the pad of type C composite material on terrazzo and concrete floors.

### Examples 13-18

### Evaluation of Pads Comprising the Composite Material According to the Present Invention with Water with Degreaser (100 mL of 5 Brix Degreaser in 3 L of Water i.e. 0.17 Brix) with Floors with a R10 Non-Slip Surface

The observations made in the evaluation of 33 cm (13 inch) diameter pads of M-F resin and type A, B, C, D and E composite materials on the cleaning of anti-slip R10 industrial flooring using a LoLine® NLL332 motorised floor cleaner with a reservoir but no sucking up of water from Numatic International Ltd with a single pad rotating at 200 rpm and water with degreaser (100 mL 5 Brix degreaser in 3 L of water i.e. 0.17 Brix) are summarized in Table 5 below.

TABLE 5

| | | Initial pad | | ability to cope | damage to pads after |
|---|---|---|---|---|---|
| | composite | thickness | cleaning | with floor | 454 m anti-slip R10 |
| Example | material | [mm] | quality | irregularities | flooring |
| 13 (comparative) | 100* M-F resin | 20 | good | good | destroyed |
| 14 (invention) | A | 20 | good | good | wear but still usable |
| 15 (invention) | B | 20 | good | good | wear but still usable |
| 16 (invention) | C | 20 | good | good | wear but still usable |
| 17 (invention) | D | 20 | good | good | wear but still usable |
| 18 (invention) | E | 15 | good | very good | wear but still very |
| | | | | | usable |

*pads are cut from blocks of M-F resin without thermal compression

The cleaning effect realised on the anti-slip R10 industrial flooring with all the pads evaluated was adjudged to be good i.e. inferior to that realised on smoother flooring and the ability of all the pads to cope with the floor irregularities was adjudged to be at least good with that of the pad of composite material E being adjudged to be very good. However, whereas after 454 m (200 m²) of anti-slip R10 industrial flooring there was visible wear with pads of type A, B, C, D and E composite materials according to the present invention, the pad of M-F resin without post-manufacturing thermal compression was destroyed.

### Examples 19-24

### Evaluation of Pads Comprising the Composite Material According to the Present Invention with Water with Degreaser (500 mL of 5 Brix Degreaser in 15 L of Water i.e. 0.17 Brix) with Floors with a R11 Non-Slip Surface

The observations made in the evaluation of 33 cm (13 inch) diameter pads of M-F resin and type C, D and E composite materials on the cleaning of anti-slip R11 industrial flooring using a DIBO® Scrubber CT70-BT70 motorised floor cleaner which accommodates two pads each 33 cm (13 inch) in diameter mounted laterally on the left and on the right both rotating at 200 rpm with the left pad rotating clockwise and the right pad rotating anti-clockwise and water with degreaser (100 mL of 5 Brix degreaser in 3 L of water i.e. 0.17 Brix) are summarized in Table 6 below.

TABLE 6

| | composite | mounting | Initial pad | linear distance | Final pad thickness |
|---|---|---|---|---|---|
| | material | position | thickness [mm] | travelled [m] | [mm] |
| 19 (comparative) | 100* M-F resin | right | 20 | 200 | 4 |
| 20 (comparative) | 100* M-F resin | right | 20 | 250 | 2 |
| 21 (invention) | D | left | 20 | 250 | 16 |
| 22 (invention) | D | left | 20 | 300 | 14 |
| 23 (invention) | E | right | 15 | 200 | 12 |
| 24 (invention) | E | left | 15 | 300 | 11# |

*pads are cut from blocks of M-F resin without thermal compression
#compared with the pad of invention example 23 the visual perception is that the pad is thinner than the pad of invention example 24, but the thickness measurement is made more difficult by the significantly greater surface roughness due to the higher wear of the M-F resin segments of the surface.

It is clear from the results in Table 6 that composite materials D and E are significantly more durable than the M-F resin pads. Moreover, composite material E appears to be more durable than composite material D with a thickness loss of 4 mm compared with a thickness loss of 6 mm after travelling a linear distance of 300 m.

### Examples 25-26

### Evaluation of Type E Pads Comprising the Composite Material According to the Present Invention with Water and Water with Degreaser (100 mL of 5 Brix Degreaser in 3 L of Water i.e. 0.17 Brix) with an Epoxy Floors with a R10 Non-Slip Surface

The purpose of these experiments was to realise images of demonstrating the cleaning efficacy of the type E pads comprising the composite material according to the present invention on an R10 non-slip epoxy floor. The LoLine® NLL332 motorised floor cleaner with a reservoir but no sucking up of water from Numatic International Ltd with a single pad rotating at 200 rpm used in Examples 13 to 18 was used for these experiments.

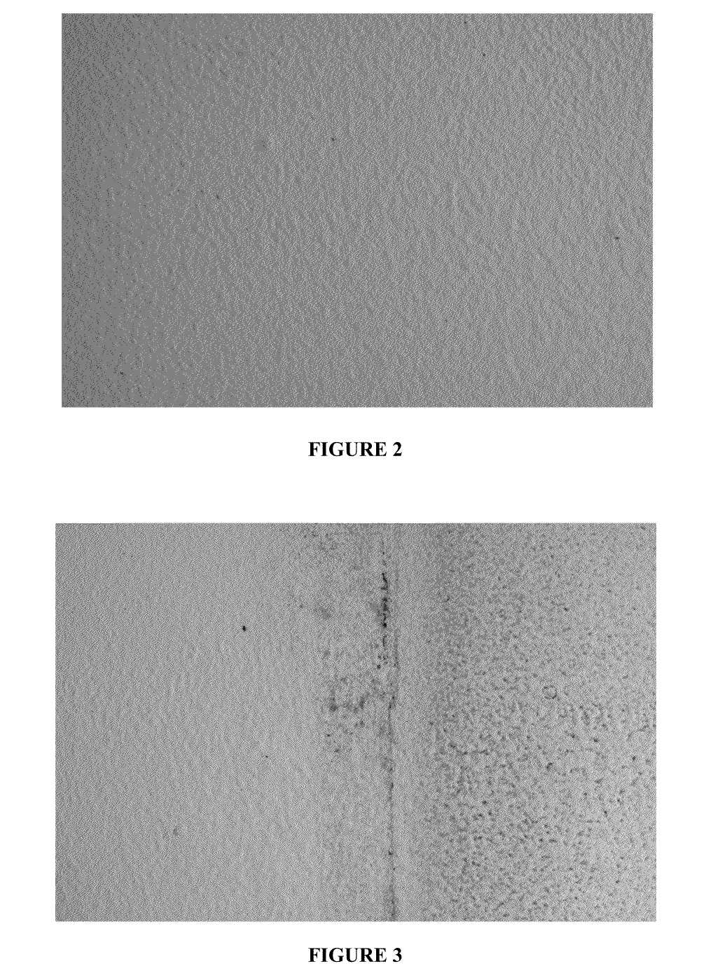

FIG. 2 shows a high resolution black and white image of the original state of the floor under a mat clearly showing the structure of the grey-blue epoxy coating on the floor surface. FIG. 3 shows a high resolution black and white image of a track made by cleaning with the type E pad with just water on the left side and the original dirty floor on the right. The odd speck of dirt in the cleaned area indicates a good level of cleaning. The other images were taken with a lower resolution camera.

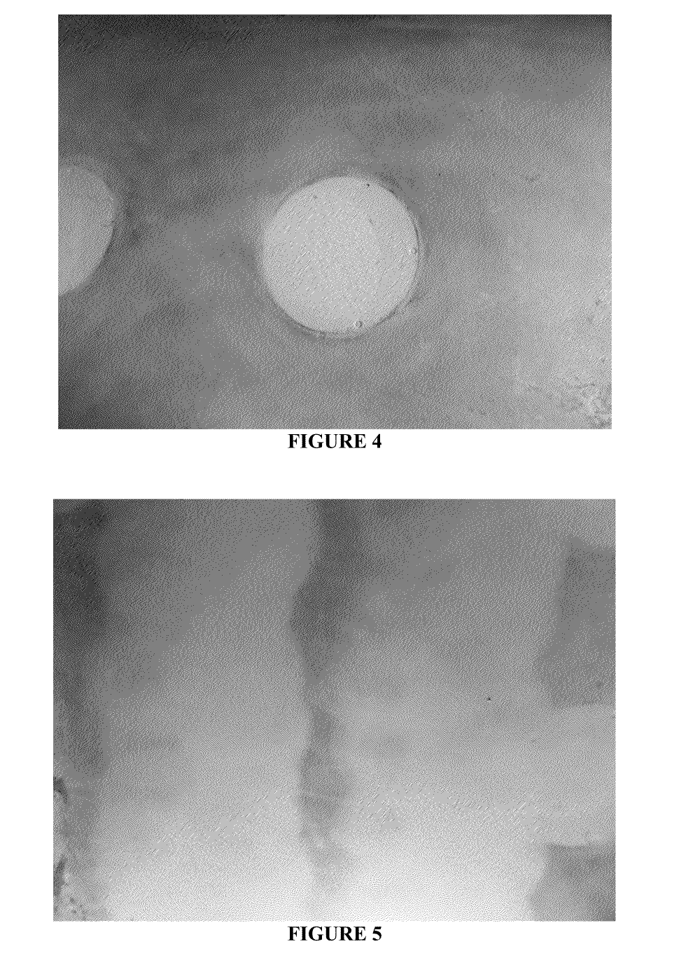

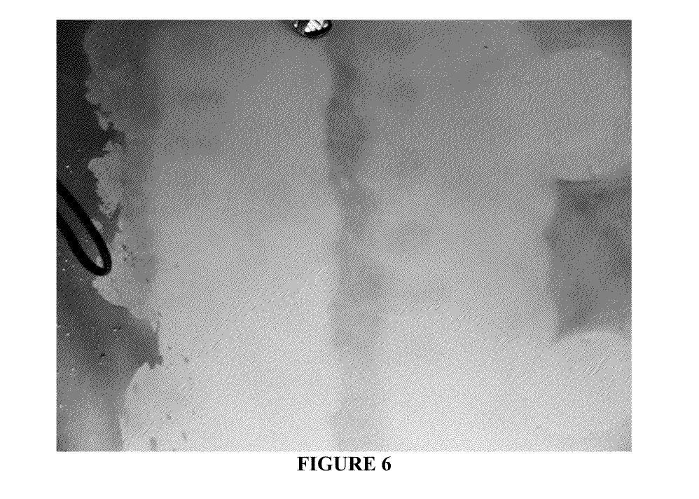

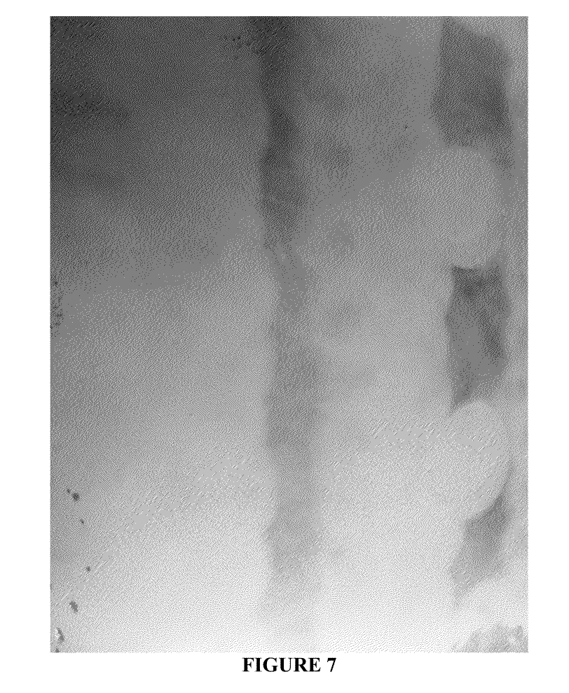

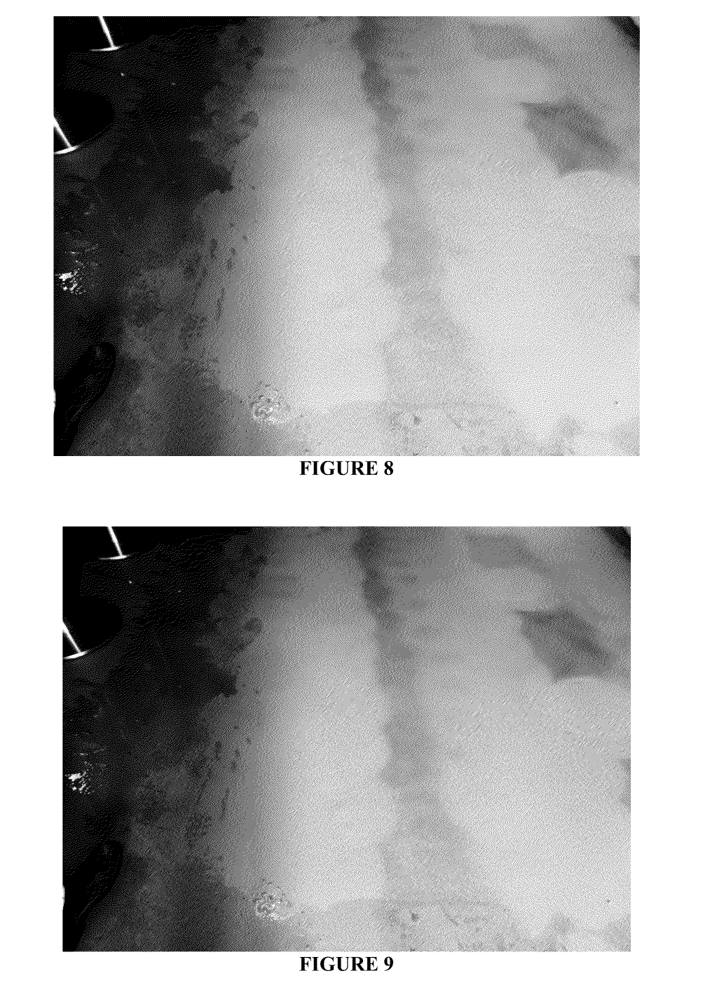

FIG. 4 shows a circular patch prevented from becoming dirty by being under a foot of a table showing the original state of the blue-grey epoxy floor coating surrounded by the dirty floor prior to cleaning with the type E pad. FIGS. 5 to 9 show an approximately vertical uncleaned area with on the left a track made by cleaning with the type E pad with water to which degreaser had been added and on the right a track made by cleaning with the type E pad with just water. Visually there was a clear difference in cleaning quality psychometrically characterised as very good and good respectively, the difference being confirmed by independent observers. The very good level of cleaning obtained with the type E pad with water with degreaser provided an even level of cleanliness as seen in the left hand track, whereas the good level of cleaning obtained with the type E pad with just water seen on the right, provided a lower level of cleanliness over the whole area, there being clearly less clean areas among cleaner areas leading to a more patchy impression. These differences were very hard to reproduce in camera images and this problem was compounded by the poor image reproduction of electrophotographic printers.

### Examples 27-31

### Production of a Blocks of Composite Material and Foams Comprising Composite Material Produced by Comminution of the Blocks of Composite Material, Mixing with Reactive Adhesive and Compression in a Mould without Additional Heat to a Foam Slab with a Density Greater than 100 kg/m³

Composite materials F and G were produced by first weighing the M-F particles onto a moving belt at a weighing platform and then the PU-particles onto the same moving belt at the weighing platform, the moving belt transporting the particles to a mixer in which the mixing of the M-F particles and PU-particles is accompanied by spraying the mixed particles with the type of MDI or types of MDI in sequence as described in Table 7 and compressing in a mould to a block of 2.09×1.06×0.50 m³ without additional heat to a density of 65 kg/m³ and allowing to harden for the times given in Table 7. The spraying began once 100% of the particles had been weighed out. The delay between weighing particular mm-sized particles and their arrival at the mixer via the continuously moving belt is no more than 120 s.

TABLE 7

| | | Example 27 | Example 28 |
|---|---|---|---|
| | Particle | Composite | Composite |
| | size [mm] | material F | material G |
| type 1 M-F particles* (% by wt) | 35 | 14 | 12 |
| PU-particles (% by wt) | 25 | 74 | — |
| PU-particles (% by wt) | 9 | — | 76 |
| Voramer ™ MF1503 (% by wt) | — | 12 | 12 |
| hardening time [h] | — | 48 | 48 |

*manufacturer 2

Composite materials F and G were first subjected to comminution over a 25 mm sieve to which reduced pressure was applied and the resulting mm-sized particles mixed with a Voramer™ MF1503, an MDI reactive adhesive, and compressed in a mould to a block of 2.09×1.06×0.45 m³ without additional heat to the density given in Table 8 below and allowed to harden for 48 hours as summarised below in Table 8.

TABLE 8

| | Particle size | Example 30 | Example 31 |
|---|---|---|---|
| | [mm] | Foam A | Foam B |
| Comminuted composite | 25 | 88 | — |
| material F (% by wt) | | | |
| Comminuted composite | 25 | — | 88 |
| material G (% by wt) | | | |
| Voramer ™ | — | 12 | 12 |
| MF1503 (% by wt) | | | |
| density [kg m⁻³] | — | 140 | 160 |
| hardening time [h] | — | 48 | 48 |

Pads of Foam A and Foam B cut from the blocks of Composite F and G respectively were mounted on a motorised floor cleaner and their cleaning performance evaluated. These foams were found to exhibit a similar cleaning performances and durabilities to those observed for pads of Composite Materials D and E.

Foam B was thermally compressed at 210° C. for 3 minutes resulting in a permanent compression of 10% thereby providing a pad of Foam C with a density of 178 kg m⁻³ with exhibits enhanced cleaning performance over pads of Foam B.

### Examples 32-35

### Production of a Blocks of Composite Material and Foams Comprising Composite Material Produced by Comminution of the Blocks of Composite Material, Mixing with Reactive Adhesive and Compression in a Mould without Additional Heat to a Foam Slab with a Density Greater than 100 kg/m³

Composite materials H and I were produced by first weighing the M-F particles onto a moving belt at a weighing platform and then the PU-particles onto the same moving belt at the weighing platform, the moving belt transporting the particles to a mixer in which the mixing of the M-F particles and PU-particles is accompanied by spraying the mixed particles with the type of MDI or types of MDI in sequence as described in Table 9 and compressing in a mould to a block of 2.09×1.06×0.50 m³ without additional heat to a density of 65 kg/m³ and allowing to harden for the times given in Table 9. The delay between weighing particular mm-sized particles and their arrival at the mixer via the continuously moving belt is no more than 120 s. In the case of Example 32 spraying began once 100% of the particles had been weighed out and in the case of Example 33 spraying of the first sprayed type of MDI once 10% by weight of the particles had been weighed. This means that in the case of Example 33 at the time spraying began there were only mm-sized particles of M-F in the mixer and that by the time spraying with the second sprayed type of MDI began all of the mm-sized particles of M-F had been wetted with the first sprayed type of MDI.

TABLE 9

| | Particle | Example 32 | Example 33 |
|---|---|---|---|
| | size | Composite | Composite |
| | [mm] | material H | material I |
| Type 1 M-F particles* (% by wt) | 35 | — | 11 |
| Type 2 M-F particles# (% by wt) | 35 | 14 | — |
| PU-particles (% by wt) | 25 | 74 | — |
| PU-particles (% by wt) | 9 | — | 74 |
| % of total particles weighed | — | 100% | 10% |
| at which spraying of | | | |
| mixing particles started | | | |
| Voramer ™ MF1503 (% by wt) | — | 12 | 7 |
| Voramer ™ RF1026 (% by wt) | — | — | 8** |
| hardening time [h] | — | 48 | 24 |

*manufacturer 1
#manufacturer 2
**spraying started immediately after spraying of mixing mm-sized particles with Voramer ™ MF1503 had been performed

Composite material I of Example 33 exhibited superior cohesion over that of Composite material H.

Composite materials H and I each were first subjected to comminution to a volume averaged particle size of 25 mm and once 100% has been weighed sprayed with Voramer™ MF1503, an MDI, in a mixer and then compressed in a mould to a block of 2.09×1.06×0.45 m³ without additional heat to the density given in Table 10 below and allowed to harden for 48 hours as summarised below in Table 10.

TABLE 10

| | Particle | Example 34 | Example 35 |
|---|---|---|---|
| | size [mm] | Foam C | Foam D |
| Comminuted composite | 25 | 88 | — |
| material H (% by wt) | | | |
| Comminuted composite | 25 | — | 88 |
| material I (% by wt) | | | |
| Voramer ™ MF1503 (% by wt) | — | 12 | 12 |
| density [kg m⁻³] | — | 160 | 160 |
| hardening time [h] | — | 48 | 48 |

Pads of Foam C and Foam D cut from the blocks of Composite H and I respectively were mounted on a motorised floor cleaner and their cleaning performance evaluated. These foams were found to exhibit a similar cleaning performances and durabilities to those observed for pads of Composite Materials D and E.
It is to be understood that although preferred embodiments, specific constructions and configurations, as well as materials, have been discussed herein for devices according to the present invention, various changes or modifications in form and detail may be made without departing from the scope and spirit of this invention. Steps may be added or deleted to methods described within the scope of the present invention.

1. A process for producing a composite material, the process comprising the steps of: providing mm-sized particles comprising at least particles of a porous optionally at least partially compressed open-cell melamine formaldehyde resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ to form a block of said composite material.

2. The process according to claim 1, wherein said mm-sized particles of porous open-cell melamine formaldehyde are provided by grinding melamine formaldehyde resin comprising porous open-cell and non-porous parts into particles of porous open-cell and non-porous melamine formaldehyde resin and separating said porous open-cell melamine formaldehyde resin particles from said non-porous melamine formaldehyde resin particles.

3. The process according to claim 1, wherein said open cell melamine-formaldehyde particles are selected from particles produced by comminution of open-cell melamine formaldehyde blocks with a density of about 8 to about 12 kg/m³ and from open-cell melamine formaldehyde blocks produced, which has subsequently been subjected to thermal compression

4. The process according to claim 1, wherein said mm sized particles of at least one non-rigid foamed resin are mm-sized particles of latex and/or polyurethane foam particles.

5. The process according to claim 4, wherein at least 10% by weight of said mm-sized particles are mm-sized polyurethane foam particles.

6. The process according to claim 4, wherein at least 10% by weight of said mm-sized particles are mm-sized latex particles.

7. The process according to claim 1, wherein an accelerator is present during at least part of said mixing process.

8. The process according to claim 1, wherein said composite produced is subsequently at least 15% permanently thermally compressed under a pressure of 1.5×10³ to 6.0×10³ kg/m².

9. The process according to claim 1, wherein said block of said composite material is subjected to comminution and the resulting mm-sized particles mixed with a second reactive adhesive in a concentration of 3 to 18 g of said second reactive adhesive per 100 g of mm-sized comminuted composite material particles and said mixture is irreversibly compressed in a mould without additional heat to a density greater than 100 kg/m³ to form a foam slab comprising said composite material.

10. The process according to claim 9, wherein said density is less than 180 kg/m³.

11. The process according to claim 9, wherein said reactive adhesive and said second reactive adhesive are the same.

12. The process according to claim 1, wherein said composite produced is laminated with a backing material.

13. A composite material obtainable by a process for producing a composite material, the process comprising the steps of: providing mm-sized particles comprising at least particles of a porous optionally at least partially compressed open-cell melamine formaldehyde resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ to form a block of said composite material.

14. The composite according to claim 13, wherein said mm-sized particles of porous open-cell melamine formaldehyde are provided by grinding melamine formaldehyde resin comprising porous open-cell and non-porous parts into particles of porous open-cell and non-porous melamine formaldehyde resin and separating said porous open-cell melamine formaldehyde resin particles from said non-porous melamine formaldehyde resin particles.

15. The composite according to claim 13, wherein said open cell melamine-formaldehyde particles are selected from particles produced by comminution of open-cell melamine formaldehyde blocks with a density of about 8 to about 12 kg/m³ and from open-cell melamine formaldehyde blocks produced, which has subsequently been subjected to thermal compression

16. The composite according to claim 13, wherein said mm sized particles of at least one non-rigid foamed resin are mm-sized particles of latex and/or polyurethane foam particles.

17. The composite according to claim 14, wherein at least 10% by weight of said mm-sized particles are mm-sized polyurethane foam particles.

18. The composite according to claim 16, wherein at least 10% by weight of said mm-sized particles are mm-sized latex particles.

19. The composite according to claim 13, wherein an accelerator is present during at least part of said mixing process.

20. The composite according to claim 13, wherein said composite produced is subsequently at least 15% permanently thermally compressed under a pressure of 1.5×10³ to 6.0×10³ kg/m².

21. The composite according to claim 13, wherein said block of said composite material is subjected to comminution and the resulting mm-sized particles mixed with a second reactive adhesive in a concentration of 3 to 18 g of said second reactive adhesive per 100 g of mm-sized comminuted composite material particles and said mixture is irreversibly compressed to a block in a mould without additional heat to a density greater than 100 kg/m³ to form a foam slab comprising said composite material.

22. The composite according to claim 21, wherein said density is less than 180 kg/m³.

23. The composite according to claim 21, wherein said reactive adhesive and said second reaction adhesive are the same.

24. A laminate comprising a composite material, said composite material being obtainable by a process for producing a composite material, the process comprising the steps of: providing mm-sized particles comprising at least particles of a porous optionally at least partially compressed open-cell melamine formaldehyde resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ to form a block of said composite material.

25. The laminate according to claim 24, wherein said laminate comprises a backing material and a block of said composite material.

26. The laminate according to claim 24, wherein said laminate comprises a backing material and a foam comprising said composite material.

27. A method of using a composite material for polishing and/or cleaning applications with a liquid, said composite material being obtainable by a process for producing a composite material, the process comprising the steps of: providing mm-sized particles comprising at least particles of a porous optionally at least partially compressed open-cell melamine formaldehyde resin and mm-sized particles of at least one non-rigid foamed resin; mixing said particles with at least one reactive adhesive in a concentration of 6 to 18 g of reactive adhesive per 100 g of mm-sized particles; reacting said reactive adhesive with said particles in the presence of aerial moisture thereby bonding said particles together during said mixing process; transporting said mixture into a mould; and irreversibly compressing said mixture to a block in a mould without additional heat to a density greater than 50 kg/m³ to form a block of said composite material.

28. The method according to claim 27, wherein said composite material is a pad and the liquid does not comprise a cleaning-enhancing additive.

29. The method according to claim 27, wherein said composite material is in a pad and the liquid does not comprise a cleaning-enhancing additive.

30. The method according to claim 28, wherein said pad is used in combination with a motorized floor cleaning machine on which it is mounted.

31. The method according to claim 29, wherein said pad is used in combination with a motorized floor cleaning machine on which it is mounted.
